(19) United States
(12) Patent Application Publication
(10) Pub. No.: US 2012/0272667 A1
(43) Pub. Date: Nov. 1, 2012

(54) AIR CONDITIONING LUBRICANT DELIVERY VESSEL, METHOD AND SYSTEM

(76) Inventors: Tony Ferraro, Mississauga (CA); Andrew Chochol, Allison (CA); Leslie Pawlowski, Fenwick (CA)

(21) Appl. No.: 13/500,899

(22) PCT Filed: Oct. 9, 2009
(86) PCT No.: PCT/CA09/01447

§ 371 Date: Jul. 23, 2012

(51) Int. Cl. F25B 45/00; B67D 3/00; B65D 81/26

(52) U.S. Cl. 62/77; 62/292; 206/204; 222/544

(57) ABSTRACT

A vessel for use in an air conditioner recharging system contains a desiccant that may limit moisture in a hygroscopic fluid, such as liquid lubricant and/or dye. The vessel may thus limits the amount of moisture introduced as a result of replacing or injecting lubricant. The vessel may contain an amount of pure lubricant for the air-conditioning system, or a lubricant and fluorescent dye to aid in detecting leaks.

### FIELD OF THE INVENTION

The present invention relates generally to air conditioning systems, and more particularly to an air conditioning lubricant delivery vessel, method and system.

### BACKGROUND OF THE INVENTION

The majority of modern transport vehicles include an air conditioning system typically used to cool passenger compartment and operating compartments of the vehicle. Such air conditioning systems typically include a closed fluid circuit, in which refrigerant is urged through condenser coils, and evaporator coils by way of an expansion valve, by a compressor. Commonly, the compressor includes an electric motor. Such systems do not allow refrigerant and other circulating fluid to escape.

In order to keep the compressor lubricated, a relatively small amount of lubricant is added to the circulating refrigerant. From time to time, the refrigerant and accompanying lubricant needs to be replaced or added. To this end, known air conditioning evacuation and filling systems are known. For example, Robinair, Mastercool, TIF, RTI, Wigam, Ecotechnics, all produce readily available automotive air conditioning charging, recycling, and recovery tools. Typically, these evacuate the contents of an air conditioning system through a service valve, and separate refrigerant from the lubricant. Fresh refrigerant and lubricant may then be added through the service valve.

Lubricant is typically added from a container interconnected with or forming part of the air conditioning evacuation and filling system. The container is often transparent or translucent, to allow an operator to see the amount of lubricant dispensed and remaining. Such containers are often formed of thermoplastics, or glass. As lubricant is drawn, displaced lubricant is replaced with air.

Additionally, if an air conditioning system develops a leak, a lubricant containing a concentrated fluorescent dye that assists in locating the leak(s) may be added through the service valve. To pinpoint the leak(s), a technician may scan the air conditioning system for leaks with a UV or near UV lamp that causes the dye to fluoresce to reveal the exact location of the leak.

Modern air conditioning systems have become particularly susceptible to moisture. This is particularly the case for more powerful and efficient systems. In some air conditioning systems (e.g. high voltage systems), refrigerant including moisture may behave like a conductor, causing a short within the compressor. Likewise, the mere presence of moisture may change the electrical properties of the air conditioning system, including the dielectric nature of any refrigerant or lubricant, and thus the electrical characteristics of the compressor. This, in turn, may impact the remainder of the vehicle's electrical system. This may cause particularly acute problems for hybrid vehicles.

To compound problems, new lubricants have been introduced in recent years. These lubricants are suited to new refrigerants. Different air conditioning systems require different lubricants. Examples lubricants include polyalkylene glycol (PAG) and polyolester (POE) polyvinylethlene (PVE), poly-alpha-olefine (PAO) and mineral oil. Many of these new lubricants are synthetic, and are hydrophilic and/or hygroscopic. Keeping moisture out of such lubricants has therefore become a particular concern. This problem is acute as such lubricants are exposed to air, as may for example be the case when lubricant is drawn from a container and displaced by air as it is added to an air conditioning system, as described above.

### SUMMARY OF THE INVENTION

In accordance with an embodiment of the present invention, a vessel for use in an air conditioner recharging systems is provided. The vessel contains a desiccant that may limit moisture in a hygroscopic fluid, such as liquid lubricant or dye. The vessel may thus limits the amount of moisture introduced as a result of replacing or injecting lubricant. Moreover, the vessel may keep any contained lubricant and any additives such as fluorescent dyes clean and dry.

The vessel may contain pure lubricant for the air-conditioning system. Alternatively, the vessel may contain a lubricant and fluorescent dye to aid in detecting leaks. The dye may be concentrated or diluted, depending on the type of air conditioning system to be serviced.

The vessel may have gradient markings or other means of liquid level indication on the container to aid in accurate dispensing volumes.

The vessel may be prefilled with a determined amount of lubricant and/or dye to allow a factory to fill and seal of said container.

In accordance with an aspect of the present invention, there is provided a lubricant vessel for connection to an air conditioner recharging system. The vessel comprises: a container; a liquid lubricant received in the container; a desiccant in the container

In accordance with another aspect of the present invention, there is provided a method of adding a lubricant to an air conditioning system. The method comprises: providing a container containing the lubricant and a desiccant; drawing lubricant from said container into a service valve of said air conditioning system.

In accordance with another aspect of the present invention, there is provided a vessel for connection to an air conditioner recharging system. The vessel comprises: a container; a hygroscopic fluid in the container to be drawn by the air conditioner recharge system; a desiccant in the hygroscopic fluid.

In accordance with yet another aspect of the present invention, there is provided an air conditioning charging and recovery system. The system comprises a lubricant vessel comprising: a substantially sealed container holding a liquid lubricant and a desiccant; a hose removably interconnected with the vessel to allow liquid lubricant to be drawn from the container.

In accordance with yet another aspect of the present invention, there is provided a dispenser assembly for connecting a vessel to an air conditioning system. The dispenser assembly comprises a hose connector for connecting the vessel to a hose of the air conditioner recharging system to provide lubricant from the vessel, and a release valve for interconnection with a bore in communication with a region above a fluid level of a lubricant in the vessel to allow air to displace liquid lubricant drawn from the vessel.

In accordance with yet another aspect of the present invention, there is provided a lubricant vessel for connection to an air conditioner recharging system. The vessel comprises: a container; a liquid lubricant received in the container; a plug having a tube extending downwardly into the container; a desiccant; an air passage in flow communication with a region between a fluid level of the lubricant and a bottom of the plug; a threaded lid; a dispenser assembly for connecting the vessel to the air conditioner recharging system, the dispenser assembly comprising a hose connector for connecting the tube to the air conditioner recharging system, and mountable on the container in place of the threaded lid.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate by way of example only, embodiments of the present invention,

FIG. 1 is a perspective view of a lubricant delivery vessel for use in an air conditioning recharging system, including a container and cap, exemplary of an embodiment of the present invention;

FIG. 2 is a side view of the vessel of FIG. 1, with cap on;

FIG. 3A is a cross-sectional view of FIG, 2, along lines B-B;

FIG. 3B is an enlarged view of a portion of FIG. 3A;

FIG. 4 is a top plan view of the vessel of FIG. 2, with cap removed;

FIG. 5 is an exploded view of the vessel of FIG. 1;

FIG. 6 is a side perspective view of the container of FIG. 1, including an adapter assembly for connection with a fluid exchange apparatus for an air conditioning system;

FIG. 7 is a side view of the container of FIG. 1, with the adapter assembly of FIG. 6;

FIG. 8A is a side view of a cross-sectional view of FIG. 6, along lines B-B;

FIG. 8B is an enlarged view of a portion of FIG. 8A;

FIG. 9 is a bottom view of the adapter assembly of FIG. 6;

FIG. 10 illustrates an air conditioner service equipment including the container of FIG. 1;

FIG. 11 is a side view of a vessel for a lubricant, exemplary of another embodiment of the present invention;

FIG. 12 is a cross-sectional view of FIG. 11, along lines A-A; and

FIG. 13 is an exploded view of the vessel of FIG. 11

### DETAILED DESCRIPTION

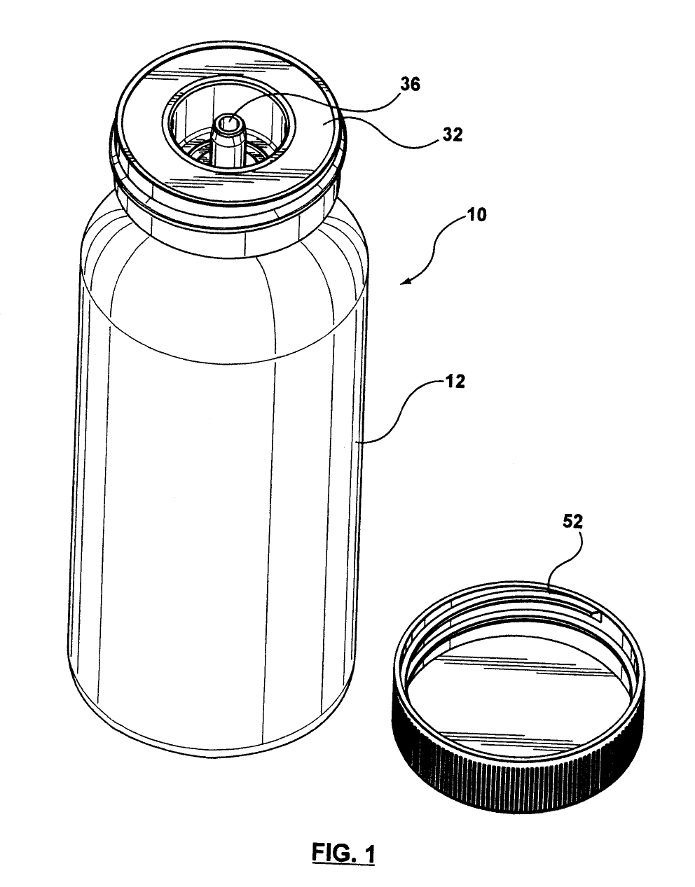

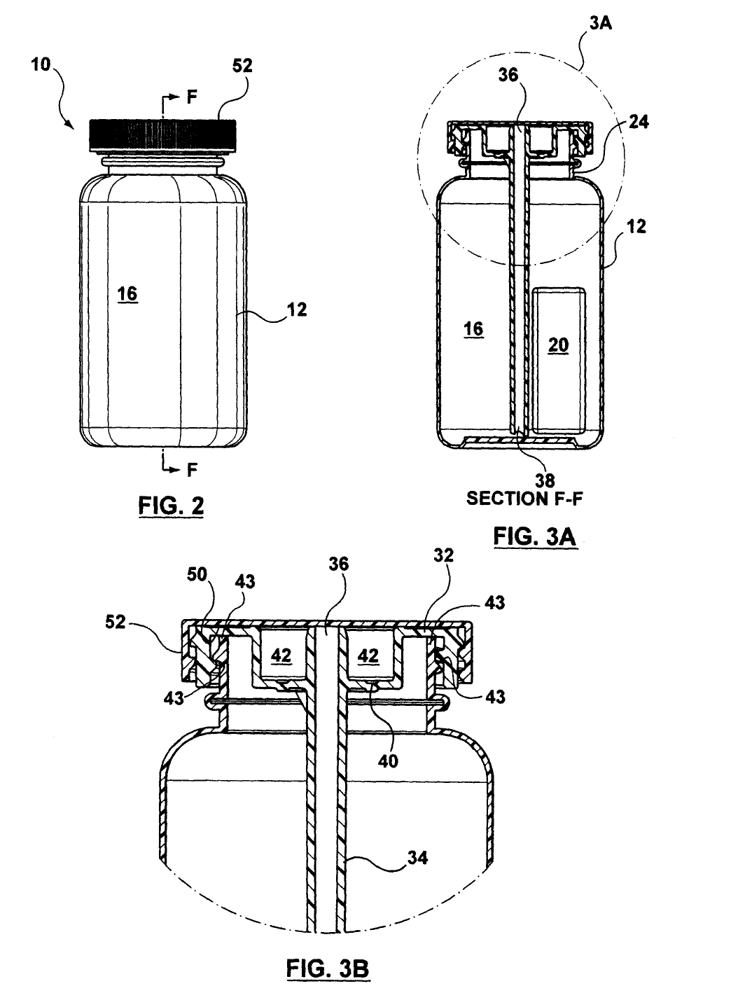

FIGS. 1-5 illustrate a lubricant vessel 10, including a complementary lid 52, exemplary of an embodiment of the present invention. As illustrated, vessel 10 includes an outer bottle-shaped container 12 that receives a defined quantity of lubricant 16 and a desiccant 20. Container 12 includes a neck 24 having a generally circular top opening 14 (visible in FIG. 5). The outer wall of neck 24 surrounding opening 14 includes an exterior thread 22.

Container 12 may be formed using plastic—such as thermoplastic polymer, for example a high density polyethylene. Alternatively, container 12 may be formed from another thermoplastic polymer, such as polyethylene terephthalate, glass, tin, stainless steel, aluminium or other suitable material. As required or desired the interior of container 12 may be coated to reduce the attraction and/or condensation of water on body 12. An optional coating may be formed using fluoride, polyethylene, or the like.

Container 12 may have any suitable size. Typical sizes may be between about 30 mL and 1 L. Other suitable sizes may be appreciated by those of ordinary skill. Container 12 may be transparent, semi-transparent or translucent and also have markings on its side (not illustrated) showing the amount of liquid lubricant remaining/dispensed.

Container 12 is filled with a lubricant 16 used to lubricate an air conditioning system. Example lubricants include oil, polyolester (POE), polyvinylethlene (PVE), poly-alpha-olefine (PAO), and mineral oil. Aswell, PAG and POE are available in several viscosities. For example PAG is available in the following viscosities: 40, 66, 100, 125 and 150. POE is available in a low and high viscosity, which are particularly well suited for use with R-134a air conditioner refrigerants. As will be appreciated, the term liquid as used herein is intended to refer to liquids of differing viscosities, gels, sols, colloidal dispersions in solution, and the like.

In addition to lubricant 16, container 12 may optionally contain a fluorescent dye to assist in finding leaks. Example dyes are widely known and used. Known manufactures include Uview, Snap-On Tools and Spectronics.

A plug assembly 30 includes a hollow tube 34 extending from a generally circular plug 32, complementary in shape and size to top opening 14. Tube 34 includes top and bottom openings 36, 38. Plug 32 is installed within the interior of top opening 22 to substantially seal container 12. To this end, the interior of neck 24 may be threaded to engage plug 32. Plug 32 may likewise be threaded. Alternatively, plug 32 may be friction fit, glued, or otherwise sealed in opening 14. Tube 34 extends downwardly from plug assembly 30 into lubricant 16 to allow the lubricant to be drawn therefrom from proximate the bottom of container 12, through top opening 36 of tube 34. Bottom opening 38 is positioned proximate, but not in contact with the bottom of container 12, as best viewed in FIG. 3.

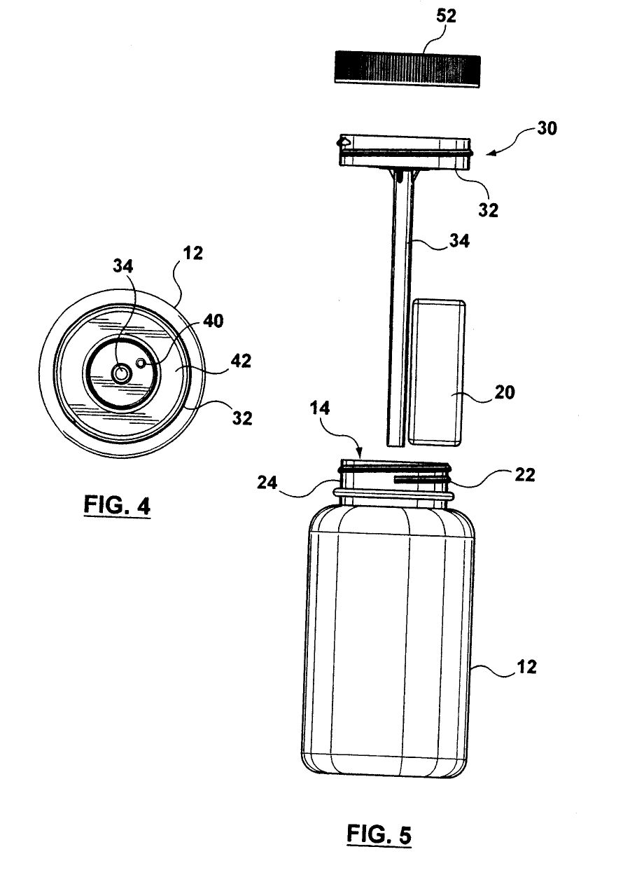

An annular groove 42, best viewed in FIG. 4, extends around top opening 36 of tube 34 in plug 32. A small passage 40, sufficient to allow air to pass (e.g. 1 mm or 2 mm diameter), extends from the bottom of groove 42 into the interior of bottle 10 through plug 32.

With the exception of opening 36 and passage 40, plug assembly hermetically seals bottle body 12. A thin peelable foil 50 is affixed to seal the top of plug 32, and in particular opening 36 and passage 40, prior to initial use, and thus completely seals bottle body 12. A removable cap 52 may be screwed atop foil 50 on thread 22 of neck 24 to further seal vessel 10, in a re-sealable manner.

Desiccant 20 is packaged in a pouch. The pouch may be a polyester felt bag. Desiccant 20 (including its pouch) is chosen to be suitable for immersion in liquid lubricants and dyes used in air conditioning systems. Example suitable desiccants include products from Flow-Dry Technology Inc. Such desiccants may be similar to AD-1™ molecular sieve 8×12 beads used in current automotive air conditioning systems, with weight 5 grams. Of course, other weights (eg. 1 to 20 grams) will also work. Desiccants may include silicon oxide, sodium oxide, aluminium oxide, potassium oxide, quartz, silicon dioxide, cristobalite, and the like, in suitable combinations. Other molecular sieve desiccants may be formed using natural or synthetic zeolites. Other desiccants suitable to a particular lubricant 16 will be readily apparent to those of ordinary skill.

In this way, and as will become apparent, desiccant 20 remains in lubricant 16 to absorb moisture in container 12. Desiccant 20 may float on top of the lubricant 16 or be fully or partially submersed. Conveniently, it may adequately keep lubricant 16 dry and extend the shelf life of the vessel 10 and its contents, keeping it useful for air-conditioning system service. A charge of typical desiccant 20 may be able to remove about 1400 ppm of moisture in a container 12 of 500 mL and 2800 ppm in a container of 250 mL before desiccant 20 becomes saturated. Of course, a greater quantity of desiccant will remove more moisture.

As should now be appreciated, vessel 10 thus provides a substantially sealed container 12 containing lubricant and a desiccant.

Vessel 10 may be packaged by blow moulding, or otherwise forming body 12; filling it to a desired level with liquid lubricant 16; inserting desiccant 20; and plugging opening 14 with plug assembly 30. Thereafter, foil 50 may be heat sealed or glued to the perimeter of opening 22, formed by neck 24, using an adhesive. Cap 52 may then be screwed thereon. Vessel 10 is then ready for sale, and use in conjunction with an air conditioning charging, recycling, and recovery system, as further described below.

In the depicted embodiment, plug 30 is affixed within opening 14 to prevent refilling. To this end, plug 30 may be glued by lubricant 43 as illustrated in FIG. 3B. As will be appreciated, plug 30 (or a similar plug) could be removable to allow refilling with a suitable lubricant/dye. Alternatively, container 12 with desiccant 20 inserted could be provided in bulk allowing users to add a suitable lubricant 16 and seal container 10.

As should appreciated vessels, like vessel 10 can be used to store a variety of lubricants and/or lubricants and dye as described above. An air conditioner repair specialist may possess a number of such vessels. Each vessel may store a different lubricant or a different combination of lubricant and dye for a different air conditioning system.

Of note, conventional containers formed of thermoplastics, other polymers and materials have been found to allow moisture to seep into their interior despite being substantially sealed. Conveniently, vessel 10 with desiccant 20 allows seeped moisture to be absorbed from lubricant 16. As well, direct contact of desiccant 20 with lubricant 16 has been found to be more effective than the placement of a desiccant within an air passage or air filled region.

As illustrated, in FIG. 1, in order to use vessel 10 with an air conditioning charging, recycling, and recovery system, cap 52 may be removed by unscrewing. Foil 50 may be peeled back.

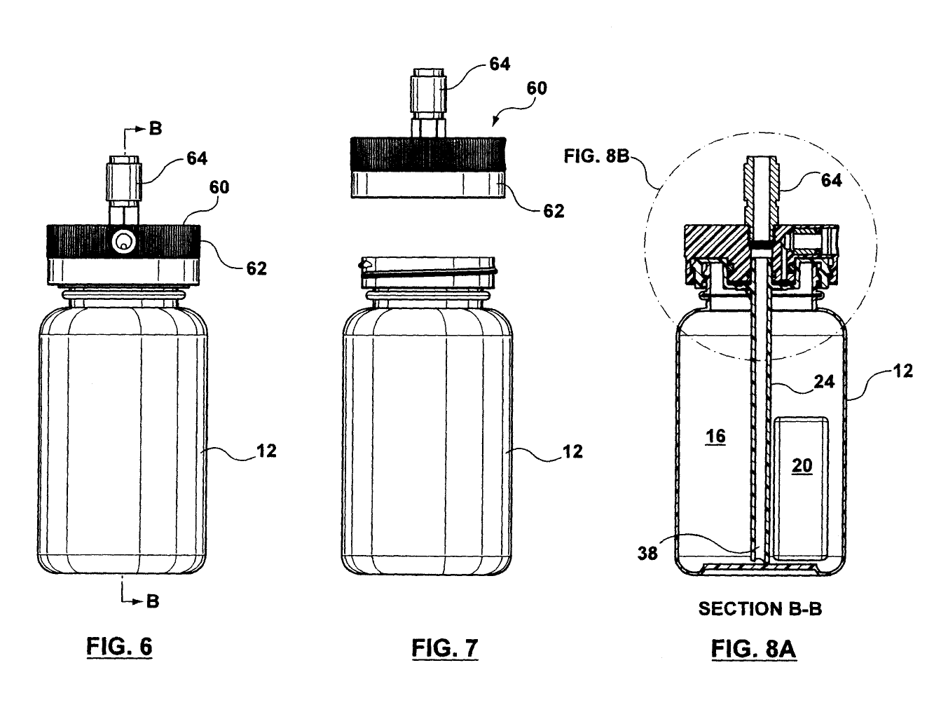

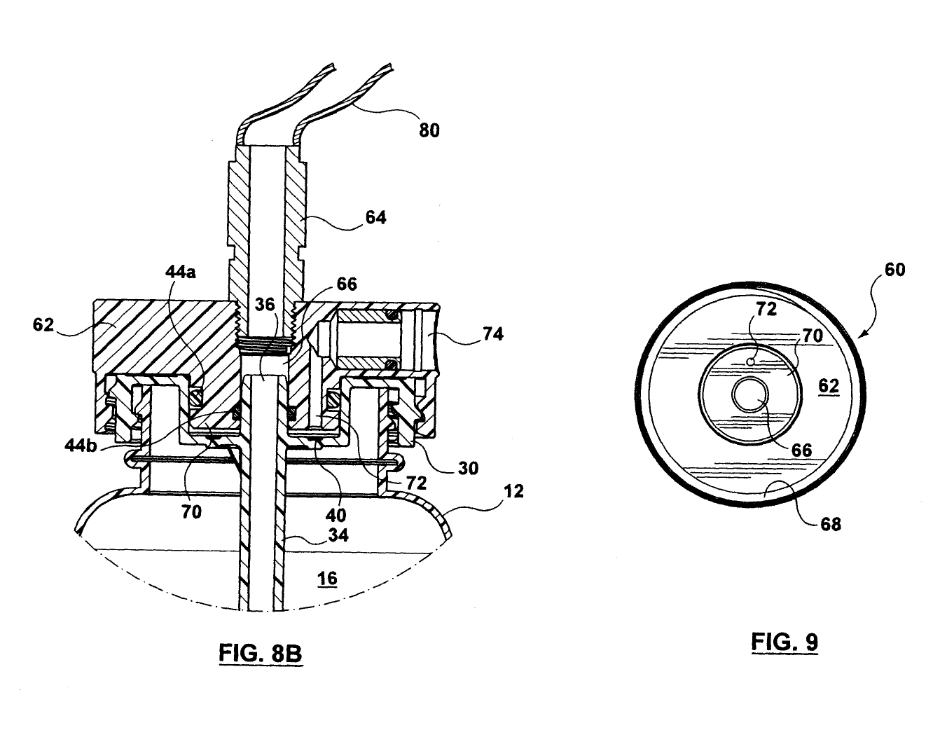

Then, a dispensing adaptor 60 illustrated in FIGS. 6-9 may be threaded on thread 22 in place of cap 50. Dispensing adaptor 60 includes an interior thread complementary to exterior thread 22. Adaptor 60 further includes generally puck shaped body 62, and a hose connector 64 extending therefrom. Hose connector 64 is mounted on opening 66, positioned to be in flow communication with opening 36 of tube 34, and coaxial with tube 34, when adaptor 60 is installed on container 12 (as best viewed in FIG. 8A). Further, an exterior skirt 68 having interior threads extends around the periphery of body 62, and an interior skirt 70 surrounds an opening 66. O-rings 44a and 44b may be formed interior and exterior to skirt 70, respectively.

A bore 72 within adaptor assembly 60 connects a further bleed opening 40 with a valve 74 in flow communication with ambient air. Valve 74 may be a check valve, or a one-way valve. Valve 74 may be a conventional gas valve that opens in the presence of about 0.2 to 2 PSI (0.01379 to 0.1379 BAR) The valve may open in a vacuum state of about 0.5-5 inches of vacuum. (0.6665 to 6.665 mbar). In the depicted embodiment, valve 74 extends perpendicular to bore 72, and the axis of opening 66, from the side of body 62. Of course, placement elsewhere is possible.

In use, cap 52 is removed, as depicted in FIG. 1. Foil 50 is peeled, exposing the top of plug 32. Dispensing adaptor 60 is screwed on thread 22, and the hose of an air conditioning recharge system is connected to hose connector 64. An example hose 80 is depicted in FIG. 8B.

The hose is thus in flow communication with tube 34. Interior skirt 72 engages annular groove 42. Bore 72 may be aligned with opening 40 to provide flow communication between opening 40 and bore 72. Alternatively, air may flow in from bore 72 to opening 40 through the region annular groove 42 not occupied by interior skirt 72. As required, an O-ring seal 44a and 44b may further seal skirt 72 in groove 42 and around tube 34.

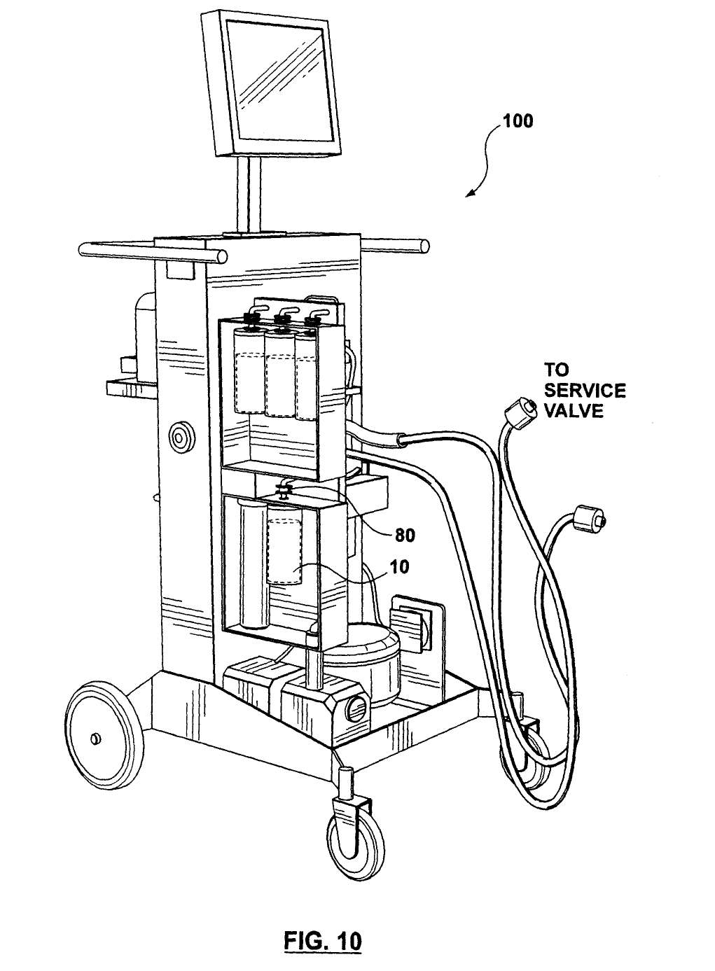

Hose 80 connected to hose connector 64 typically leads to a T-connector of an air conditioner recharging system 100, as depicted in FIG. 10, where lubricant from vessel 10 is mixed with air conditioning refrigerant. Air conditioner recharging system 100 may be a standard commercially available air conditioner recharging system marketed by Robinair, Bosch, Behr, CPS, RTI, but incorporating vessel 10, exemplary of an embodiment of the present invention. A vacuum pump may be used to remove unwanted air from the vehicle air-conditioning system. While the vehicle is in a vacuum state a solenoid can meter the amount of lubricant to draw liquid lubricant 16 from hose 80, thereby creating a vacuum at opening 40 in the region above the liquid level of lubricant. Another embodiment would use an electric pump to draw the fluid from the container into the equipment. 16.

As liquid lubricant leaves bottle 12, the vacuum, in turn, opens valve 74 to allow displaced liquid to be replaced with ambient air. Desiccant 20 remains in the bottle to absorb any moisture in the air and fluid.

A pump, such as an electric pump, draws liquid lubricant 16 from hose 80, thereby creating a vacuum at opening 40 in the region above the liquid level of lubricant 16. As liquid lubricant leaves container 12, the vacuum, in turn, releases check valve 74 to allow displaced liquid to be replaced with ambient air. Conveniently, desiccant 20 may at least partially float to the top of lubricant 16 to absorb moisture in the air.

The T-connector is further in flow communication with refrigerant to charge the cooling circuit of an interconnected air conditioner by way of a further hose, interconnected with a service valve of the air conditioner. The T-connector allows the lubricant and/or dye to be inserted into the path of refrigerant flow. This refrigerant will then push the liquid lubricant and/or dye back into the vehicle while it recharges the refrigerant of the vehicle.

Conveniently, a user of vessel 10 may have numerous such vessels in his/her stock. Each vessel 10 may contain a different type of lubricant 16, specific to certain air conditioning systems, and may be releasably attached to air conditioning recharging system 100. After each use, cap 52 may be replaced, again sealing vessel 10, for storage and future use.

In an alternate embodiment, vessel 20 may be modified to include a plunger that may be spring loaded. This plunger may exert a slight positive pressure on any contained liquid lubricant/dye. The plunger may automatically dispense the liquid lubricant/dye when a valve forming part of an interconnected air conditioner recharging system is opened to allow flow into the air conditioner recharging system. This modification would eliminate the need for tube 34 and valve 74.

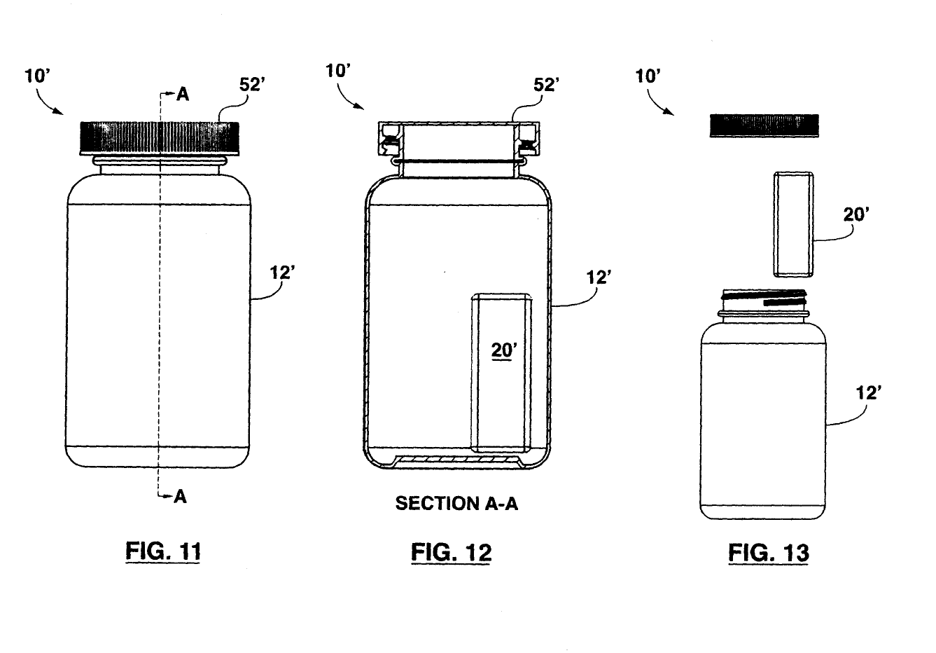

In yet a further embodiment, lubricant for use in an air conditioning system may be delivered in a vessel that may not include plug 30. Such a vessel 10′ is depicted in FIGS. 11 to 13. Vessel 10′ includes a desiccant 20′ (like desiccant 20) in a container 12′ (like container 12) for a lubricant and/or dye. A lid 52′ may be screwed or otherwise removable affixed on container 12′ to cap container 12′. Optionally, a peelable seal may cover the opening to container 12′ prior to initial use. Vessel 10′ may be suitable for use in recharge systems that are not compatible with a dispenser assembly 60, as described. Alternatively, the vessel 10′ may hold lubricant for refilling a refillable vessel like vessel 10, or lubricant for use in a single dose or multiple doses.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A lubricant vessel for connection to an air conditioner recharging system, said vessel comprising:
a container;
a liquid lubricant received in said container;
a desiccant in a package within said container;
wherein said package allows said desiccant to absorb water from said lubricant.

2. The vessel of claim 1 wherein said container is substantially sealed.

3. The vessel of claim 1, further comprising a fluorescent dye in said container.

4. The vessel of claim 1, further comprising an air passage in flow communication with a region between a fluid level of said liquid lubricant and container.

5. The vessel of claim 4, further comprising a plug having a tube extending into said container to allow said liquid lubricant to be drawn from said container.

6. The vessel of claim 1, further comprising a cap to seal said lubricant vessel.

7. The vessel of claim 5, further comprising a peelable seal, affixed to said plug to seal said air passage and a top opening of said tube.

8. The vessel of claim 5, further comprising an exterior thread on said container, about said plug.

9. The vessel of claim 1, further comprising a dispenser assembly for connecting said lubricant vessel to said air conditioner recharging system, said dispenser assembly comprising a hose connector for providing fluid communication between said liquid lubricant and said air conditioner recharging system.

10. The vessel of claim 9, wherein said dispenser assembly comprises a valve to allow air to pass into said container as lubricant is drawn from said container.

11. The vessel of claim 1, wherein said lubricant comprises at least one of polyalkylene glycol or polyolester.

12. The vessel of claim 1, wherein said desiccant comprises a molecular sieve.

13. The vessel of claim 1, wherein said desiccant comprises a zeolite.

14. The vessel of claim 1, wherein said desiccant comprises at least one of silicon oxide, sodium oxide, aluminium oxide, potassium oxide, quartz, cristobalite.

15. The vessel of claim 1, wherein said package comprises a pouch.

16. The vessel of claim 1, wherein said container is formed of high density polyethylene.

17. A method of adding a lubricant to an air conditioning system, comprising:
providing a container containing said lubricant and a desiccant;
drawing lubricant from said container into a service valve of said air conditioning system;
introducing air into said container to displace fluid drained from said container;
wherein moisture is absorbed from said air by said desiccant.

18. The method of claim 17, further comprising providing a release valve to allow said air to bleed into said container in response to negative pressure in said container.

19. The method of claim 17, further comprising mixing said lubricant with a refrigerant prior to said liquid lubricant entering said service valve.

20. The method of claim 17, wherein said liquid lubricant is drawn by from said container by a pump.

21. The method of claim 17, wherein said container further contains a fluorescent dye, and further comprising drawing said fluorescent dye with said lubricant from said container.

22. A vessel for connection to an air conditioner recharging system, said vessel comprising:
a container;
a hygroscopic fluid in said container to be drawn by said air conditioner recharge system;
a desiccant in a package in said hygroscopic fluid;
wherein said package allows said desiccant to absorb water from said hygroscopic fluid.

23. An air conditioning charging and recovery system, comprising
a lubricant vessel comprising:
a substantially sealed container holding a liquid lubricant and a desiccant;
a hose removably interconnected with said vessel to allow liquid lubricant to be drawn from said container;
wherein said desiccant is retained in said container when said liquid lubricant is drawn from said container.

24. The air conditioning charging and recovery system of claim 23, wherein said lubricant vessel comprises a valve in flow communication with a region above a fluid level of said lubricant in said container to allow air to displace liquid lubricant drawn from said container;

25. A dispenser assembly for connecting a vessel to an air conditioning system, said dispenser assembly comprising a hose connector for connecting said vessel to a hose of said air conditioner recharging system to provide lubricant from said vessel, and a release valve for interconnection with a bore in communication with a region above a fluid level of a lubricant in said vessel to allow air to displace liquid lubricant drawn from said vessel.

26. A lubricant vessel for connection to an air conditioner recharging system, said vessel comprising:
a container;
a liquid lubricant received in said container;
a plug having a tube extending downwardly into said container;
a desiccant;
an air passage in flow communication with a region between a fluid level of said lubricant and a bottom of said plug;
a threaded lid;
a dispenser assembly for connecting said vessel to said air conditioner recharging system, said dispenser assembly comprising a hose connector for connecting said tube to said air conditioner recharging system, and mountable on said container in place of said threaded lid.

27. A container for refrigerant lubricant or dye that contains a desiccant in a package or a solid dessicant.

28. The container of claim 27 comprising lubricant or dye prefilled in said container.

29. The container of claim 27 that can be filled by a user.

30. The container of claim 27 that is sealed to prevent refilling.

31. The container of 27, made of plastic

32. The container of 27, used to service air-conditioning systems

33. The container of claim 27, wherein, when said lubricant or dye is drawn from said container, a sufficient quantity of said desiccant can be retained in said container to remove substantially all moisture from the contents of said container.

34. The container of claim 27, wherein all of said desiccant can be retained in said container when said lubricant is drawn from said container.

35. The vessel of claim 1, wherein said container is re-sealable.

36. The vessel of claim 2, wherein the quantity of said liquid lubricant in said container is sufficient to service more than one air conditioner.

37. The vessel of claim 2, wherein said container is refillable.

38. The vessel of claim 1, additionally comprising air received in said container.

39. The vessel of claim 1, wherein said package retains said desiccant in said container when said lubricant is drawn from said container.

40. The method of claim 17, wherein said container is re-sealable.

41. The method of claim 17, further comprising the steps of:
retaining a portion of said lubricant in said container;
substantially sealing said container.

42. A lubricant vessel for connection to an air conditioner recharging system, said vessel comprising:
a container;
a liquid lubricant received in said container;
a solid desiccant in said container to absorb moisture in said liquid in said container.

43. The vessel of claim 42, wherein said container is re-sealable.

44. The vessel of claim 42, wherein the quantity of said liquid lubricant in said container is sufficient to service more than one air conditioner.

45. The vessel of claim 42, wherein said container is refillable.

46. The vessel of claim 42, additionally comprising air received in said container.

47. The vessel of claim 42, wherein said liquid lubricant can be drawn from said container independently of said desiccant.

48. The vessel of claim 42 wherein said container is substantially sealed.

49. The vessel of claim 42, further comprising a fluorescent dye in said container.

50. The vessel of claim 42, further comprising an air passage in flow communication with a region between a fluid level of said liquid lubricant and container.

51. The vessel of claim 50, further comprising a plug having a tube extending into said container to allow said liquid lubricant to be drawn from said container.

52. The vessel of claim 42, further comprising a cap to seal said lubricant vessel.

53. The vessel of claim 51, further comprising a peelable seal, affixed to said plug to seal said air passage and a top opening of said tube.

54. The vessel of claim 51, further comprising an exterior thread on said container, about said plug.

55. The vessel of claim 42, further comprising a dispenser assembly for connecting said lubricant vessel to said air conditioner recharging system, said dispenser assembly comprising a hose connector for providing fluid communication between said liquid lubricant and said air conditioner recharging system.

56. The vessel of claim 55, wherein said dispenser assembly comprises a valve to allow air to pass into said container as lubricant is drawn from said container.

57. The vessel of claim 42, wherein said lubricant comprises at least one of polyalkylene glycol or polyolester.

58. The vessel of claim 42, wherein said desiccant comprises a zeolite.

59. The vessel of claim 42, wherein said desiccant comprises at least one of silicon oxide, sodium oxide, aluminium oxide, potassium oxide, quartz, cristobalite.

60. The vessel of claim 42, wherein said container is formed of high density polyethylene.
